(19) United States
(12) Patent Application Publication
(10) Pub. No.: US 2024/0134575 A1
(43) Pub. Date: Apr. 25, 2024

(54) STORAGE SYSTEM AND STORAGE CONTROL METHOD

(71) Applicant: Hitachi, Ltd., Tokyp (JP)

(72) Inventors: Sachie TAJIMA, Tokyo (JP); Yoshinori OHIRA, Tokyo (JP); Shintaro ITO, Tokyo (JP); Takahiro YAMAMOTO, Tokyo (JP); Hiroto EBARA, Tokyo (JP)

(21) Appl. No.: 18/119,943

(22) Filed: Mar. 10, 2023

(30) Foreign Application Priority Data
Oct. 20, 2022 (JP) 2022-169428

(51) Int. Cl. G06F 3/06

(52) U.S. Cl. CPC G06F 3/068; G06F 3/0604; G06F 3/0638

(57) ABSTRACT

The storage system is a storage system comprising a plurality of storage nodes each including a non-volatile storage device, a storage controller that processes data read/write to the storage device, and a volatile memory, in which the storage controller stores data related to the data write in the memory, stores data that needs to be non-volatile among the data stored in the memory as log data in the storage device, makes the log data stored in the storage device redundant among a plurality of storage nodes, and performs a recovery process for the log data when a problem occurs in the log data stored in the storage device of one of the storage nodes.

### BACKGROUND OF THE INVENTION

### 1. Field of the Invention

The present invention relates to a storage system and a storage control method.

### 2. Description of Related Art

In a related art, redundant configurations have been adopted in storage systems to improve availability and reliability.

For example, JP2019-101703A proposes the following storage system.

In a storage system having a plurality of storage nodes, each storage node is provided with one or more storage devices that each provide storage areas, and one or more storage controllers that read and write requested data from and to the corresponding storage device in response to a request from a host device. Each storage controller retains predetermined configuration information necessary to read and write requested data from and to the corresponding storage device in response to the request from the host device, a plurality of pieces of the control software is managed as a redundancy group, the configuration information retained by each control software belonging to the same redundancy group is synchronously updated, and the plurality of pieces of control software constituting the redundancy group is arranged to different storage nodes so as to distribute the load of each storage node.

According to JP2019-101703A, it is possible to construct a storage system capable of continuously reading and writing even in the event of a node failure, using a technique for constructing a storage system by software (software defined storage: SDS). To improve the performance and reliability of such a storage system, it is required to protect various data by making the data non-volatile. The present invention proposes a technique for protecting control information, cache data, and the like in a storage system.

### SUMMARY OF THE INVENTION

In order to achieve the above object, one representative storage system of the present invention is a storage system including a plurality of storage nodes each including a non-volatile storage device, a storage controller that processes data read and write from and to the storage device, and a volatile memory, in which the storage controller stores data related to the data write in the memory, stores data that needs to be non-volatile among the data stored in the memory as log data in the storage device, makes the log data stored in the storage device redundant among a plurality of storage nodes, and performs a recovery process for the log data when a problem occurs in the log data stored in the storage device of any one of the storage nodes.

Also, one of the representative storage control methods of the present invention is a storage control method in a storage system including a plurality of storage nodes each including a non-volatile storage device, a storage controller that processes data read and write from and to the storage device, and a volatile memory, in which the storage controller stores data related to the data write in the memory, stores data that needs to be non-volatile among the data stored in the memory as log data in the storage device, makes the log data stored in the storage device redundant among a plurality of storage nodes, and performs a recovery process for the log data when a problem occurs in the log data stored in the storage device of any one of the storage nodes.

According to the present invention, a storage system with both high performance and high reliability can be achieved.

### BRIEF DESCRIPTION OF THE DRAWINGS

FIG. 1 is a configuration diagram of a storage system of Embodiment 1;

FIG. 2 is a diagram showing an example of the physical configuration of a storage node;

FIG. 3 is a diagram showing an example of the logical configuration of a storage node;

FIG. 4 is a diagram illustrating an overview of the disclosed storage system and storage control method;

FIG. 5 is a diagram showing an example of a memory configuration diagram;

FIG. 6 is a diagram showing an example of a configuration diagram of a storage device;

FIG. 7 is a diagram showing the structure of a log header;

FIG. 8 is an explanatory diagram of log data generation and redundancy;

FIG. 9 is a flowchart of control information update processing;

FIG. 10 is a flowchart of log creation processing;

FIG. 11 is a flowchart of cache data update processing;

FIG. 12 is a flowchart of log backup processing;

FIG. 13 is an explanatory diagram of log recovery (pattern 1);

FIG. 14 is a flowchart of log recovery processing (pattern 1);

FIG. 15 is an explanatory diagram of log recovery (pattern 2);

FIG. 16 is a flowchart of log recovery processing (pattern 2-1: control information recovery);

FIG. 17 is a flowchart of log recovery processing (pattern 2-2: cache data log recovery);

FIG. 18 is a flowchart for node failure recovery and node addition or removal; and

FIG. 19 is a garbage collection flowchart for the cache data log area.

### DESCRIPTION OF EMBODIMENTS

The embodiments of the present invention will be described in detail below with reference to the drawings. Embodiments relate, for example, to a storage system including a plurality of storage nodes on which one or more SDSs are mounted.

In the disclosed embodiment, the storage node stores control information and cache data in memory. And the storage node includes a non-volatile device. When the storage node updates control information or cache data in response to a write request from the host, the storage node stores updated data in log format in this non-volatile device. This makes it possible to make the updated data non-volatile. Then, the storage node responds to the host. Then, asynchronously, the data in memory is destaged to the storage device. In destaging, the data written to the storage system is reflected and written to the storage device. In destaging, various storage functions such as thin provisioning, snapshots, and data redundancy are provided, and processes such as creating logical-to-physical conversion addresses are performed to enable data searches and random access. On the other hand, since non-volatile device storage in the log format aims to restore data if the data is lost in the memory, the processing for storage is light and fast. Therefore, when a volatile memory is used, response performance can be improved by quickly storing data in log format in a non-volatile storage device and sending a completion response to the host device.

When data is stored in log format, control information and cache data are stored in postscript format. It is necessary to collect the free area because the data is stored in postscript. Two types of methods, a base image backup method and a garbage collection method, are selectively used to collect free space. The base image backup method is a method in which a specific entire target area of control information and cache data are written to a non-volatile device, and all updated logs during that time are discarded (collected as free area). The garbage collection method is a method for collecting a log area by identifying unnecessary logs that are not the latest among updated logs and rewriting logs other than the unnecessary logs to another area. In the event of a power outage, this base image backup and log can be used to restore control information and cache data to memory so that control information and cache data are not lost. By selectively using both methods to collect the free area, the management information for free space management can be reduced, the overhead for free area collection can be reduced, and the performance of the storage can be improved.

In addition, the data stored in the storage device in log format is made redundant in a plurality of storage nodes. Therefore, even if a failure occurs in the storage device of any one of the storage nodes, control information and cache data can be recovered from the storage devices of other storage nodes. Furthermore, by synchronizing the state of the memory of each storage node, it becomes possible to recover the data of the storage device from the memory of the own node.

### Embodiment 1

### (1) Embodiment 1

### (1-1) Configuration of Storage System of Embodiment 1

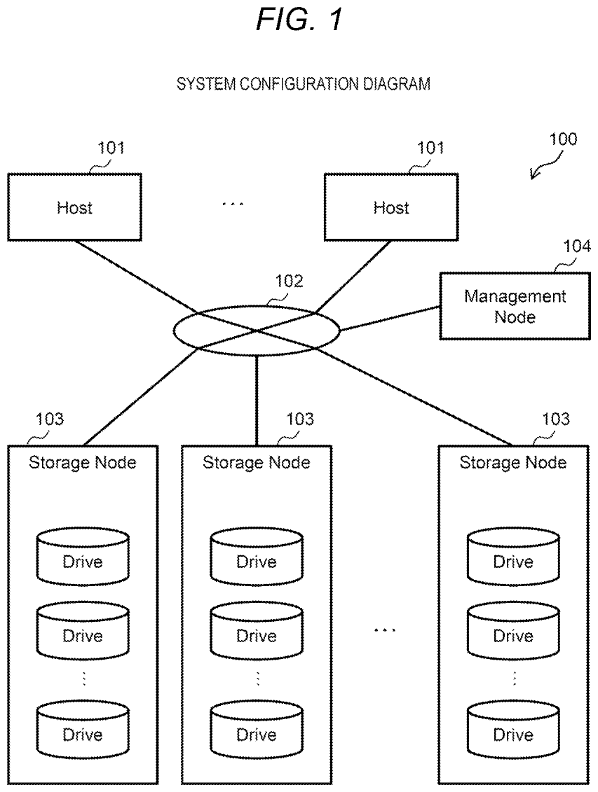

FIG. 1 shows the storage system of embodiment 1 as a whole.

A storage system 100 includes, for example, a plurality of host devices 101 (Host), a plurality of storage nodes 103 (Storage Node), and a management node 104 (Management Node). The host device 101, the storage node 103, and the management node 104 are interconnected via a network 102 composed of Fibre Channel, Ethernet (registered trademark), LAN (Local Area Network), or the like.

The host device 101 is a general-purpose computer device that transmits a read request or write request (hereinafter, collectively referred to as an I/O (Input/Output) request, as appropriate) to the storage node 103 in response to a user operation, a request from an installed application program, and the like. The host device 101 may be a virtual computer device such as a virtual machine.

The storage node 103 is a computer device that provides the host device 101 with a storage area for reading and writing data. The storage node 103 is, for example, a general-purpose server device.

The management node 104 is a computer device used by the system administrator to manage the storage system 100 as a whole. The management node 104 manages a plurality of storage nodes 103 as a group called a cluster. Although FIG. 1 shows an example in which only one cluster is provided, a plurality of clusters may be provided within the storage system 100.

Thus, the storage system 100 is configured with two or more storage nodes 103, one or more host devices 101, and one management node 104. The illustrated configuration is an example, and the host device 101, the storage node 103, and the management node 104 may be the same node. Also, the host device 101, the storage node 103, and the management node 104 may be implemented by a virtual machine or a container or may be configured to coexist as a process on one machine.

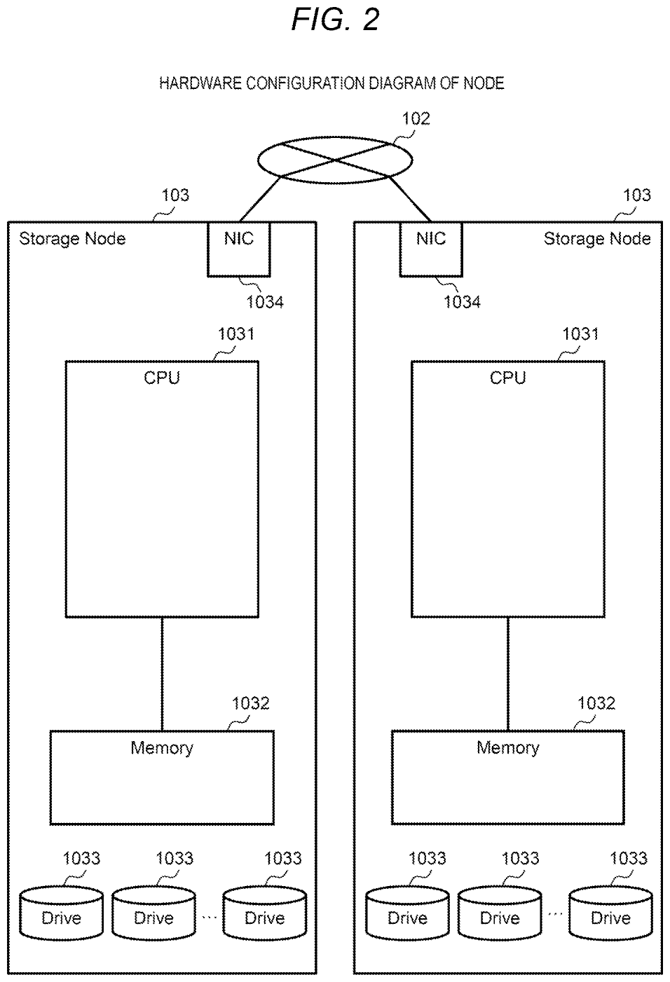

FIG. 2 is a diagram showing an example of the physical configuration of the storage node 103.

The storage node 103 includes a CPU (Central Processing Unit) 1031, a memory 1032, a plurality of storage devices 1033 (Drive), and a communication device 1034 (NIC: Network Interface Card).

The CPU 1031 is a processor that controls the operation of the storage node as a whole. The memory 1032 is composed of a semiconductor memory such as SRAM (Static RAM (Random Access Memory)) and DRAM (Dynamic RAM). The memory 1032 is used to temporarily store various programs and necessary data. As the CPU 1031 executes the programs stored in the volatile memory 1032, various processes are executed by the storage node 103 as a whole, which will be described later.

The storage device 1033 is composed of one or more types of large-capacity non-volatile storage devices such as SSD (Solid State Drive), SAS (Serial Attached SCSI (Small Computer System Interface)) hard disk drive, SATA (Serial ATA (Advanced Technology Attachment)) hard disk drive, and the like. The storage device 1033 provides a physical storage area for reading or writing data in response to I/O requests from the host system 101.

The communication device 1034 is an interface for the storage node 103 to communicate with the host device 101, other storage nodes 103, or the management node 104 via the network 102. The communication device 1034 is composed of, for example, a NIC, an FC card, and the like. The communication device 1034 performs protocol control during communication with the host device 101, other storage nodes 103, or the management node 104.

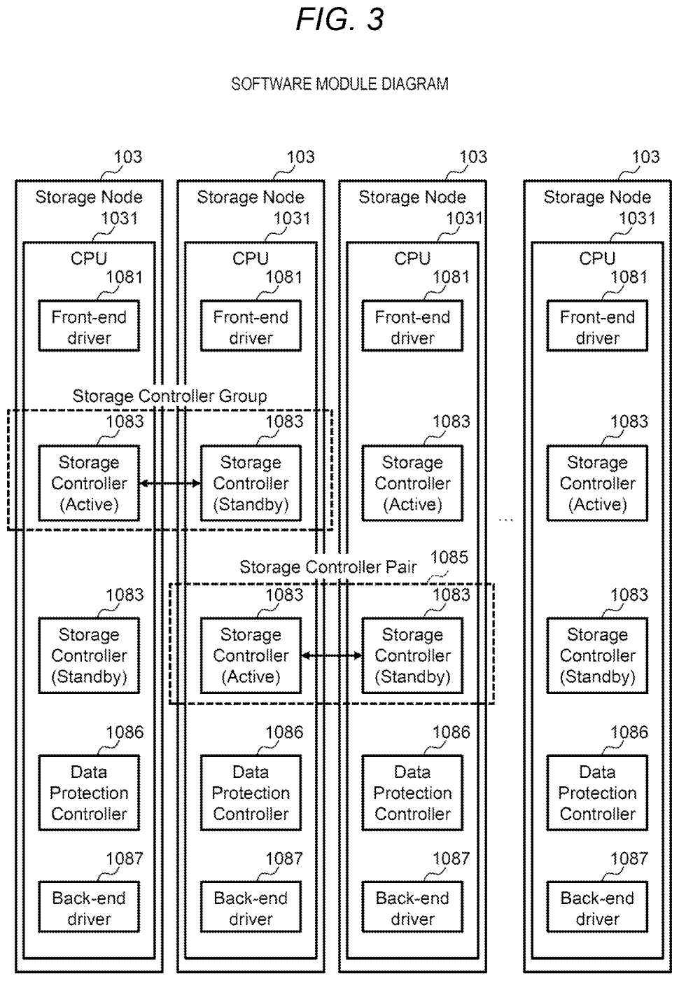

FIG. 3 is a diagram showing an example of the logical configuration of the storage node 103.

The storage node 103 includes a front-end driver 1081 (Front-end driver), a back-end driver 1087 (Back-end driver), one or more storage controllers 1083 (Storage Controller), and a data protection controller 1086 (Data Protection Controller).

The front-end driver 1081 is software having a function of controlling the communication device 1034 and providing the CPU 1031 with an abstracted interface for communication with the host device 101, other storage nodes 103, or the management node 104 for the storage controller 1083.

The back-end driver 1087 is software having a function of controlling each storage device 1033 within its own storage node 103 and providing the CPU 1031 with an abstracted interface during communication with each storage device 1033.

The storage controller 1083 is software that functions as an SDS controller. The storage controller 1083 receives an I/O request from the host device 101 and issues an I/O command corresponding to the I/O request to the data protection controller 1086. The storage controller 1083 also has a logical volume configuration function. The logical volume configuration function associates the logical chunk configured by the data protection controller with the logical volume provided to the host. For example, a straight mapping method (logical chunks and logical volumes are associated in a 1:1 ratio and setting the address of the logical chunk and the address of the logical volume to be the same) may be used, or the virtual volume function (Thin Provisioning) method (a method in which logical volumes and logical chunks are divided into small-sized areas (pages), and the addresses of the logical volumes and logical chunks are associated with each other in units of pages) may be adopted.

In the case of embodiment 1, each storage controller 1083 mounted on the storage node 103 is managed as a pair forming a redundant configuration together with another storage controller 1083 arranged on another storage node 103. This pair will be referred to as a storage controller group 1085 hereinafter.

FIG. 3 shows a case where two storage controllers 1083 constitute one storage controller group 1085. In the following description, it is assumed that the storage controller group 1085 is composed of two storage controllers 1083, but three or more storage controllers 1083 may constitute one redundant configuration.

In the storage controller group 1085, one of the storage controllers 1083 is set to a state in which I/O requests from the host device 101 can be received (current system state, hereinafter referred to as active mode). In the storage controller group 1085, the other storage controller 1083 is set to a state in which I/O requests from the host device 101 are not received (standby system state, hereinafter referred to as standby mode). A node in active mode is called an active node, and a node in standby mode is called a standby node.

In the storage controller group 1085, if a failure occurs in the storage controller 1083 set to active mode (hereinafter referred to as an active storage controller) and the storage node 103 in which the active storage controller is arranged, the state of the storage controller 1083 that has remained in standby mode until then (hereinafter referred to as a standby storage controller) is switched to the active mode. As a result, when the active storage controller becomes inoperable, the I/O processing executed by the active storage controller can be taken over by the standby storage controller.

The data protection controller 1086 is software that allocates to each storage controller group 1085 a physical storage area provided by the storage device 1033 within its own storage node 103 or within another storage node 103, and has a function to read or write specified data from or to the corresponding storage device 1033 in accordance with the above-described I/O command given by the storage controller 1083.

In this case, when the data protection controller 1086 allocates the physical storage area provided by the storage device 1033 in the other storage node 103 to the storage controller group 1085, by cooperating with the data protection controller 1086 mounted on another storage node 103 corresponding thereto and exchanging data with the data protection controller 1086 via the network 102, the data is read and written from and to the storage area according to the I/O command given from the active storage controller of the storage controller group 1085.

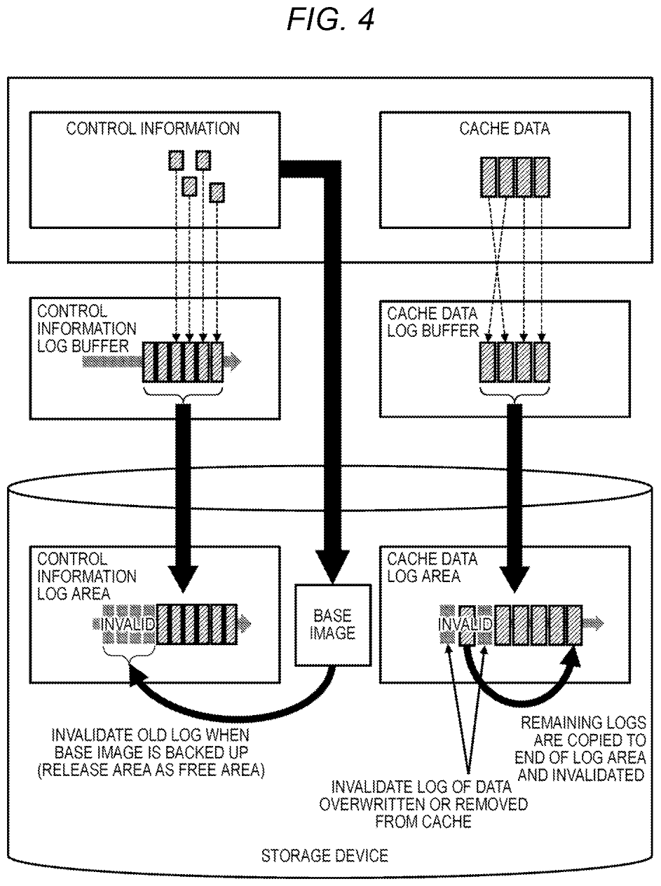

FIG. 4 is a diagram illustrating an outline of the disclosed storage system and storage control method.

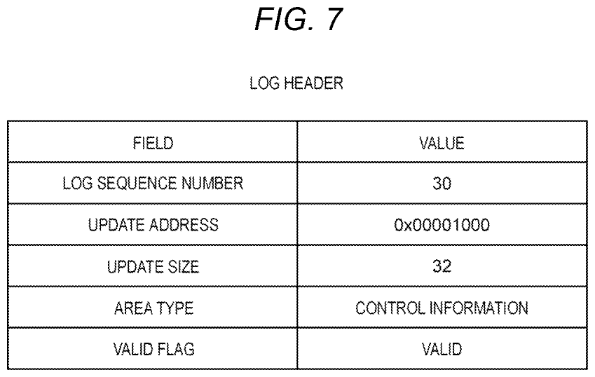

The storage controller updates control information and cache data for I/O processing from the host and various other processing. At this time, the control information and cache data on the memory are updated, and the log is stored in the storage device and made non-volatile. For this purpose, an updated log is created in the control information log buffer or cache log buffer. A log consists of updated data itself and a log header and is information indicating how control information and cache data in memory have been updated. As shown in FIG. 7, the log header contains information indicating update positions, update sizes, and order relationships between updates.

The updated log on the log buffer is written to the log area on the storage device in postscript format. This writing may be performed immediately or may be written asynchronously.

Because postscript is performed, the free area in the log area on each device gradually decreases and it becomes impossible to write. To avoid this, it is necessary to collect free space. Different methods are used for the log area for control information and the log area for cache data.

The base image backup method is used for control information. In the base image backup method, the entire control information is copied to the base image area on the storage device. After the copy is completed, all the updated logs before the start of the copy are invalidated (collect as free area).

On the other hand, the garbage collection method is used to collect free area in the log area for cache data. If cache data is overwritten or deleted from the cache (by asynchronous destage, described below), then the log of that cache data becomes invalid. The garbage collection method collects the log area as a free area by copying valid old logs to the end of the log area as new logs, excluding invalid logs.

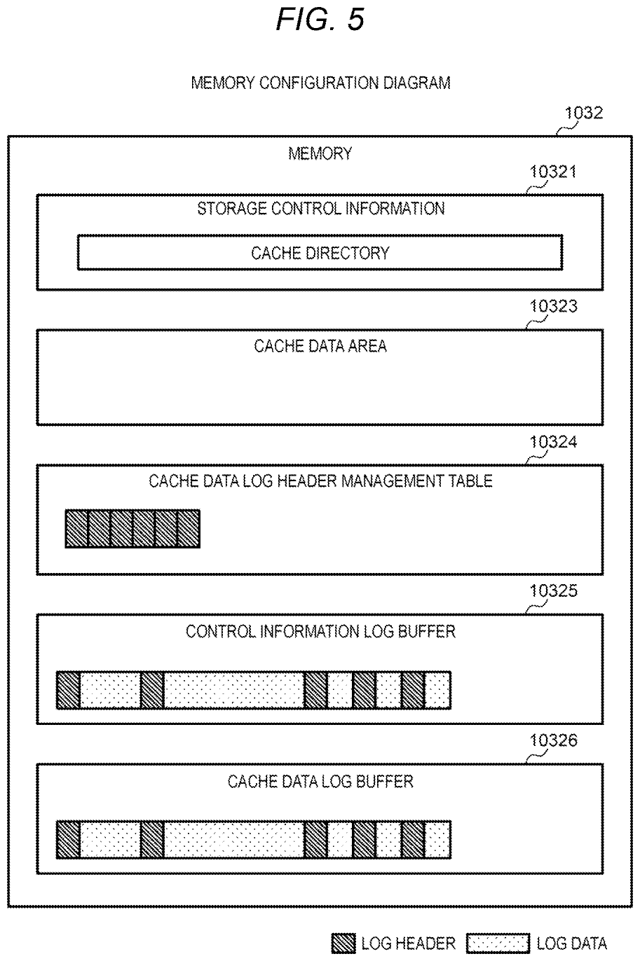

FIG. 5 is an example of a memory configuration diagram. Storage control information 10321, a cache data area 10323, a cache data log header management table 10324, a control information log buffer 10325, and a cache data log buffer 10326 are stored in the memory.

The storage control information 10321 is an area in which control information for implementing various storage functions is stored, and an example is a cache directory 10322.

The cache data log header management table 10324 is a table that stores the log headers of all cache data logs on the disk.

The control information log buffer 10325 temporarily retains logs of control information. The cache data log buffer 10326 temporarily retains cache data logs.

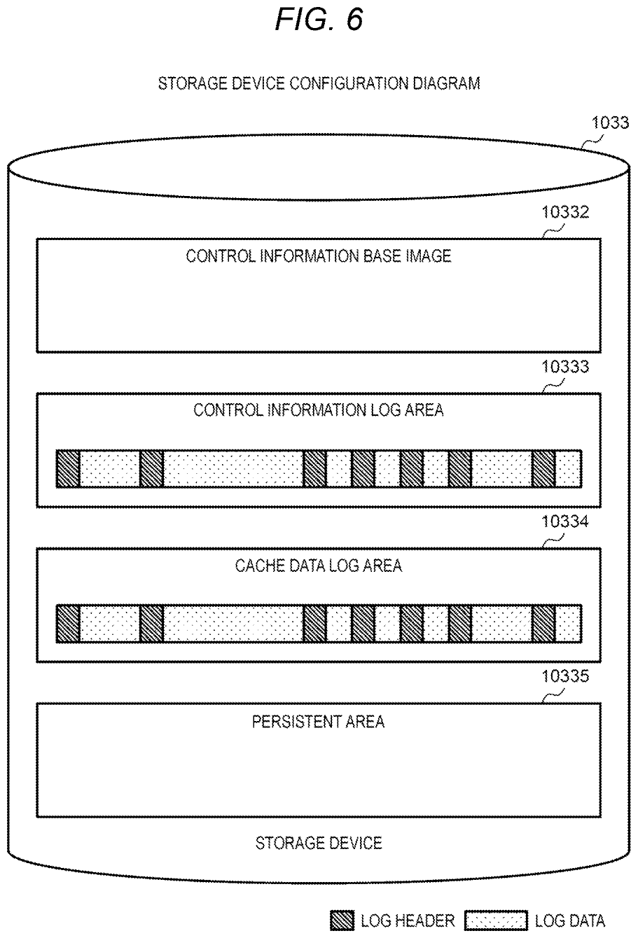

FIG. 6 is an example of a configuration diagram of a storage device. A control information base image area 10332, a control information log area 10333, a cache data log area 10334, and a persistent area 10335 exist on the storage device.

The control information base image area is an area where the entire control information is copied in the base image backup process, which will be described later. The control information log area 10333 and the cache data log area 10334 are areas to which logs are saved in log backup process, which will be described later. The persistent area 10335 is an area for storing user data managed by the data protection controller 1086.

FIG. 7 shows the structure of the log header. A log header is a table included in each log stored in a log buffer area on memory or a log area on a storage device.

Each log header includes log sequence number, update address, update size, area type, and valid flag fields.

The log sequence number field stores the log sequence number uniquely assigned to each log. The updated address field stores the address of control information or cache data to be updated for each log. The update size field stores the size to be updated. The area type field stores a value for identifying either control information or cache data. Here, it is assumed that a character string of “control information” or “cache data” is stored. A value of “valid” or “invalid” is set in the valid flag field.

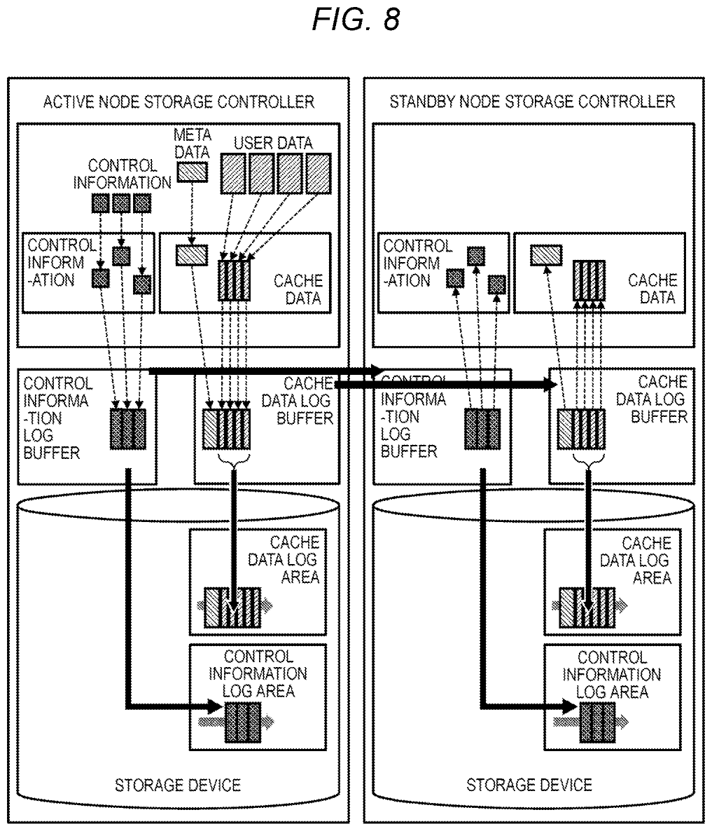

FIG. 8 is an explanatory diagram of log data generation and redundancy.

The storage controller of the active node processes I/O and updates the control information and cache data on the memory according to the operation. After that, the control information and cache data are stored in the log buffer, and log data is created from the control information and cache data in the log buffer. Specifically, the storage controller of the active node stores control information in the control information log buffer and stores cache data in the cache data log buffer. Then, log data of control information is generated from the control information in the control information log buffer and stored in the control information log area of the storage device. Similarly, log data of cache data is generated from the cache data in the cache data log buffer and stored in the cache data log area of the storage device.

Also, the storage controller of the active node transfers the log buffer control information and cache data to the standby node.

The storage controller of the standby node does not perform I/O processing but has copies of control information and cache data to take over the service when the storage controller of the active node stops.

Therefore, the storage controller of the standby node stores the control information received from the active node in the control information log buffer and stores the cache data received from the active node in the cache data log buffer. Then, using the control information and cache data stored in the log buffer, the state of the memory of the standby node is matched with the state of the memory of the active node.

Furthermore, the storage controller of the standby node generates control information log data from the control information in the control information log buffer and stores the control information log data in the control information log area of the storage device. Similarly, cache data log data is generated from the cache data in the cache data log buffer and stored in the cache data log area of the storage device.

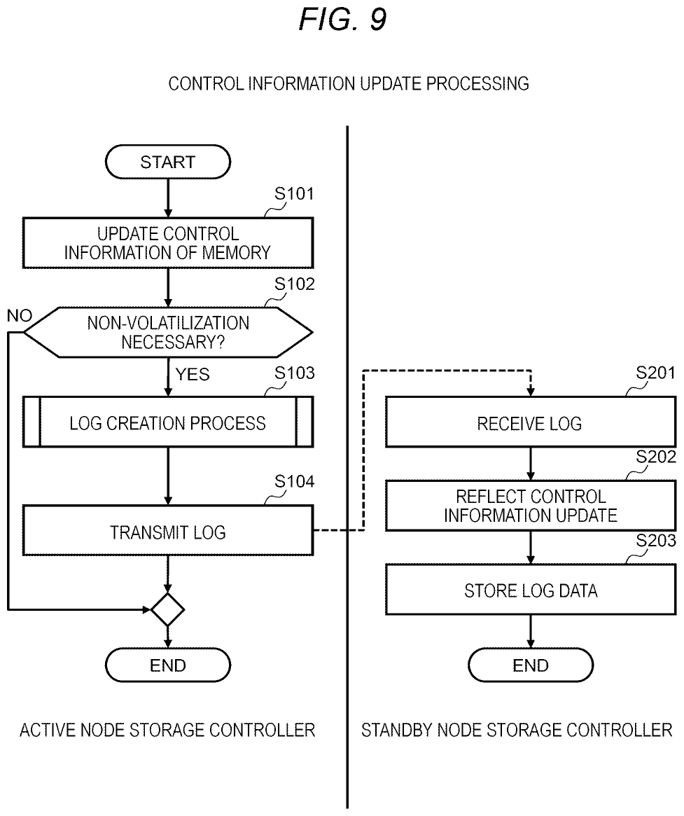

FIG. 9 is a flowchart of a control information update process. The active storage controller receives I/O, but if the active storage controller fails and becomes unable to receive I/O, the standby storage controller takes over the I/O. To achieve this, the update of control information on the active and standby is also reflected on the standby.

The control information update process is called when updating the control information on the memory. When called, a memory address and size for specifying the control information to be updated, an update value, and information indicating whether or not non-volatilization is necessary are passed.

First, the storage controller of the active node (active storage controller) updates the control information on the memory (step S101). Next, the passed non-volatile necessity is referred to and the necessity is determined (step S102).

If the non-volatilization is unnecessary (step S102; NO), the process is terminated. If non-volatilization is required (step S102; YES), log creation processing is called (S103).

After the log creation process, the active storage controller transmits the log to the storage controller of the standby node (standby storage controller) (step S104) and ends the process.

The standby storage controller receives the log from the active storage controller (step S201), reflects the control information update of the active storage controller in the memory of its own node (step S202), stores the log data in the storage device of its own node (step S203), and ends the process.

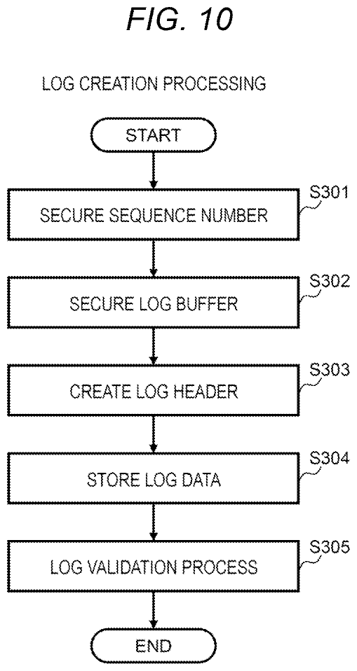

FIG. 10 is a flowchart of log creation process. In this process, “log buffer” indicates the control information log buffer when the update target is control information and indicates the user data cache log buffer when the update target is the user data cache.

First, the storage controller determines the log sequence number (step S301). The log sequence numbers are assigned in the order in which logs are created, and one log always corresponds to one log sequence number. Next, an area for writing the next log is secured in the log buffer (step S302).

In the case where log creation processing may be executed by a plurality of processes running in parallel, exclusive processing needs to be performed so that the same log sequence number is not acquired by another process and the same log buffer area is not secured by another process.

Next, a log header is created (step S303). The above-described log sequence number is stored in the sequence number field of the log header, and the values of the updated target address and updated size on the memory passed to this log creation process are stored in the updated address field and updated size field. The information type field stores “control information” when updating control information, and stores “cache data” when updating cache data.

Next, the log is stored in the log buffer (step S304). The log consists of the log header and the update target data itself. The log header is stored at the beginning of the previously reserved area on the log buffer, and the updated data itself is stored at the memory address obtained by adding the log header size to the reserved area. Finally, the log valid flag in the log header is set to “valid” (step S305), and this process ends.

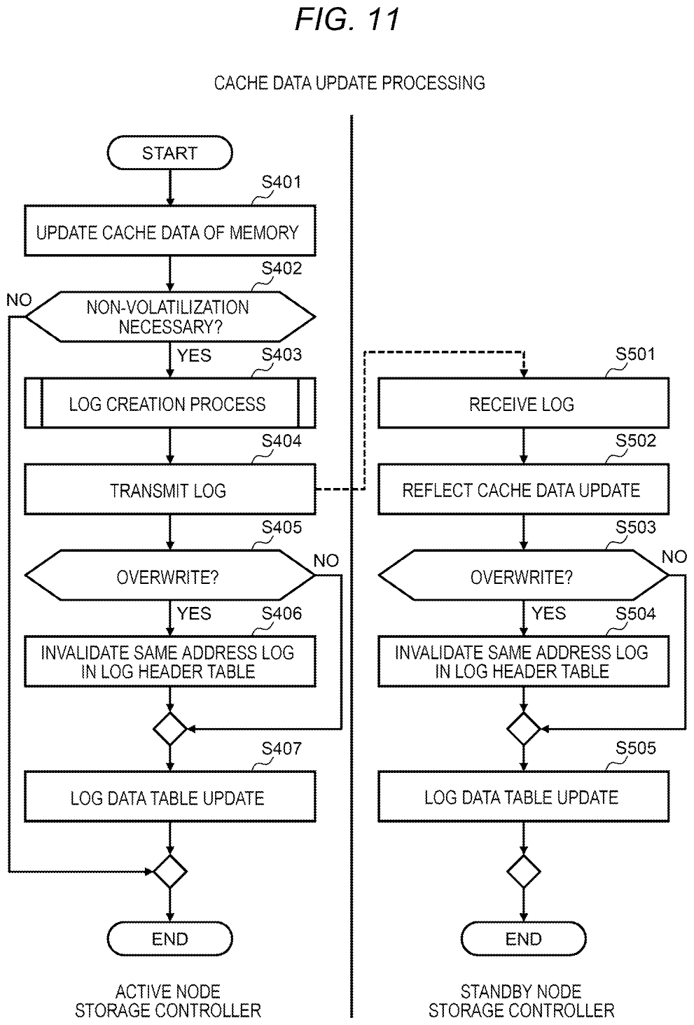

FIG. 11 is a flowchart of the cache data update process. Steps S401 to S404 are the same as steps S101 to S104, except that the target to be updated is not control information but cache data. Unlike the control information update process, in the cache data update process, steps S405 to S407 are added when it is determined in step S402 that non-volatilization is required.

In step S405, the active storage controller determines whether or not it is overwrite (step S405). That is, the cache data log header management table is referred to search for a log with the same address, and if so, overwrite is determined. If it is overwrite (step S405; YES), the log of the same address in the log header management table is invalidated (step S406). This invalidation sets the valid flag to “invalid”. After step S406, or if it is not overwrite (step S405; NO), the active storage controller adds the log header of the log created in step S403 to the log header management table (step S407) and ends the process.

The standby storage controller receives the log from the active storage controller (step S501) and reflects the cache data update of the active storage controller in the memory of its own node (step S502). After that, the standby storage controller determines whether it is overwrite (step S503). That is, the cache data log header management table is referred to search for a log with the same address, and if so, overwrite is determined. If it is overwrite (step S503; YES), the log of the same address in the log header management table is invalidated (step S504). This invalidation sets the valid flag to “invalid”. After step S504, or if it is not overwrite (step S503; NO), the standby storage controller adds the log header of the log received in step S501 to the log header management table (step S505), and ends the process.

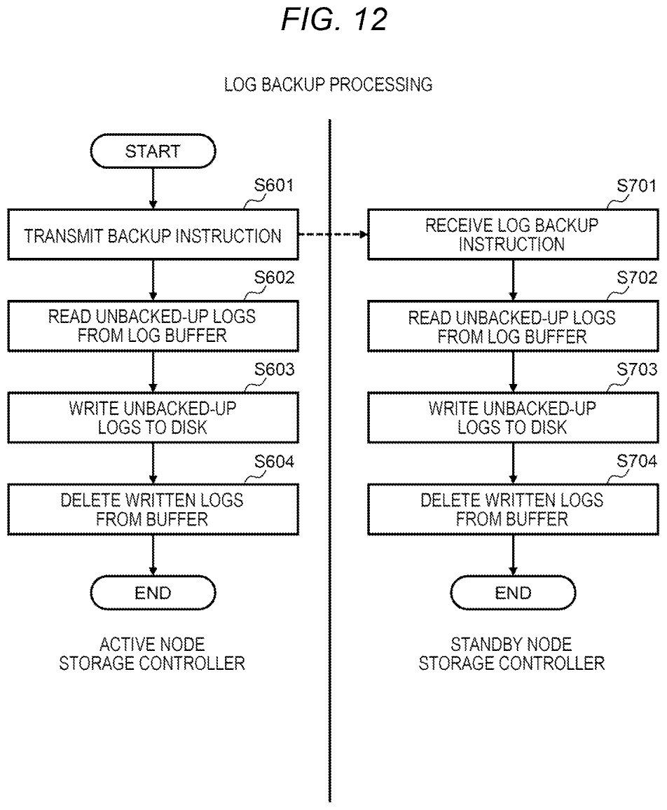

FIG. 12 shows the processing flow of the log backup process.

First, the active storage controller transmits a backup instruction to the standby storage controller (step S601). After that, the active storage controller refers to the log buffer and reads the unbacked-up log (step S602). Next, the active storage controller stores the unbacked-up log in the log area on the storage device (step S603). The write position is immediately after the last written log. After completing the write, the active storage controller deletes the log from the log buffer on the memory (step S604) and ends the process.

The standby storage controller receives a backup instruction from the active storage controller (step S701). After that, the standby storage controller refers to the log buffer and reads the unbacked-up log (step S702). Next, the standby storage controller stores the unbacked-up log in the log area on the storage device (step S703). The write position is immediately after the last written log. When the write is completed, the standby storage controller deletes the log from the log buffer in memory (step S704) and ends the process.

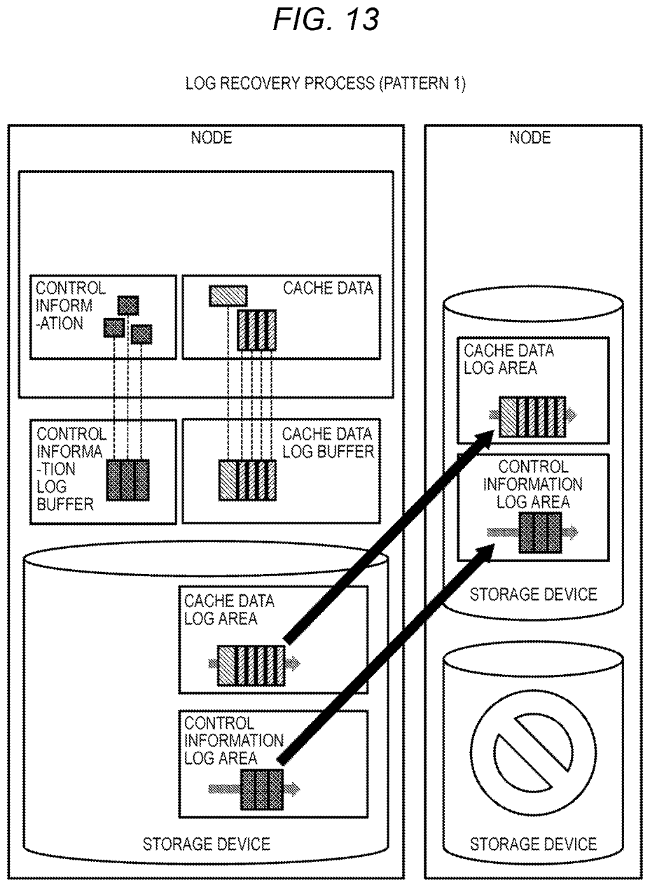

FIG. 13 is an explanatory diagram of log recovery (pattern 1). In the log recovery of pattern 1, the log is recovered from the storage device of the redundant pair node. When a storage device having a log area fails, since the log area of the storage controller group 1085 is synchronized, replication is possible from the log area of the pair node.

When a failure occurs, the failed node or management node issues a log area transfer instruction to the pair node. The pair node that received the instruction reads the log from the storage device and transfers the log to the failed node. The failed node restores the log area according to log creation processing for the control information update process and the cache data update process.

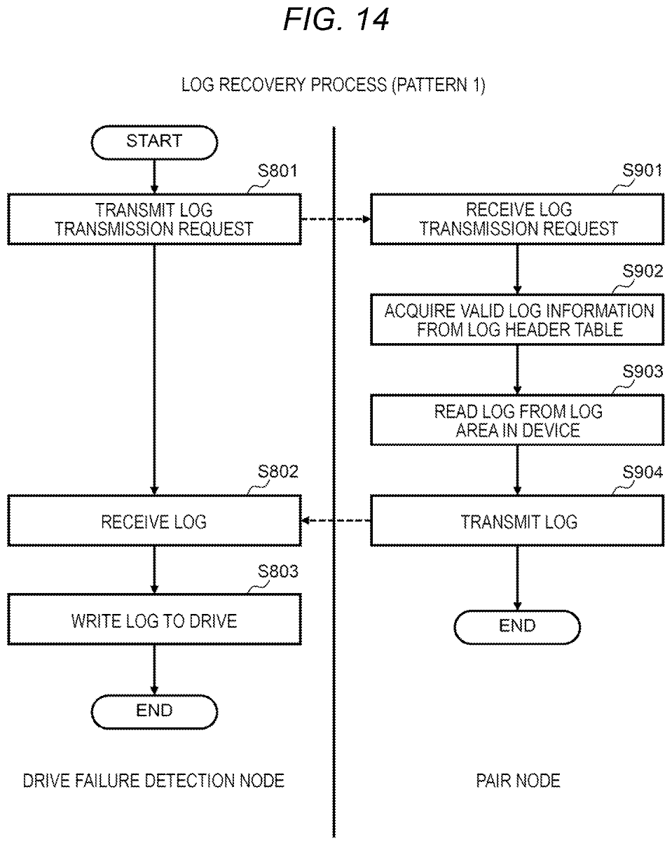

FIG. 14 is a flowchart of the log recovery process (pattern 1). The failed node transmits a log transfer request to the pair node (step S801).

When the pair node receives the log transfer request (step S901), the pair node refers to the cache data log header management table and acquires valid log information (step S902). The pair node reads the valid log from the log area in the device (step S903) and transmits the valid log to the failed node (step S904).

The failed node receives the log from the pair node (step S802), writes the log to the drive (storage device 1033) (step S803), and ends the process.

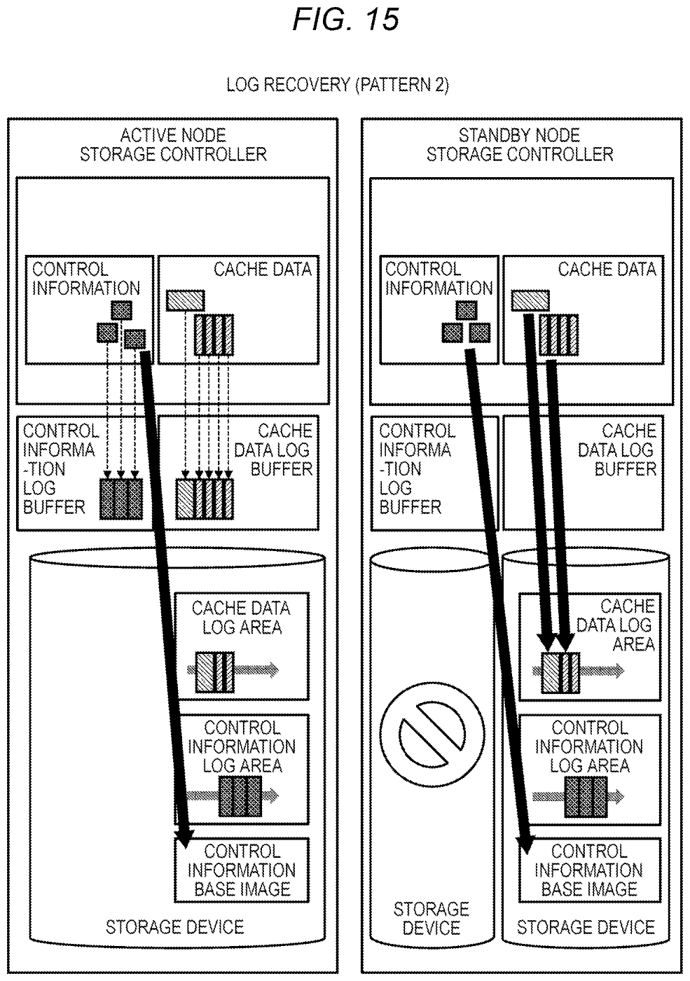

FIG. 15 is an explanatory diagram of log recovery (pattern 2). In the pattern 2 log recovery, the failed node and the pair node that detected the failure of the storage drive recover the log from the memory of their own nodes. When the storage device 1033 having the log area fails, since the information stored in the log area is also stored in the control information and cache data on the memory, replication is possible from the memory.

When a failure occurs, the failed node or management node performs the log recovery process. In this log recovery process, the failed node and the pair node back up the entire control information to the control information base image area. Also, the failed node and the pair node refer to the cache data log header management table to acquire valid log information, read data from the cache data, create a log again, and store the created log in the cache data log area.

The reason why the active side also writes data is to synchronize the base image of the control information.

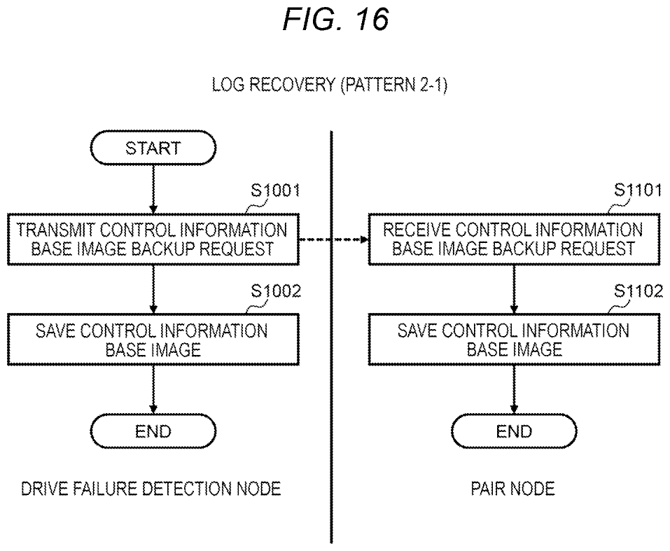

FIG. 16 is a flowchart of the log recovery process (pattern 2-1: control information recovery). First, the failed node transmits a control information base image backup request to the pair node (step S1001). Thereafter, the failed node backs up the base image of the control information in the storage device of its own node (step S1002) and ends the process.

The pair node receives a control information base image backup request from the failed node (step S1101), backs up the base image of the control information to the storage device of its own node (step S1102), and ends the process.

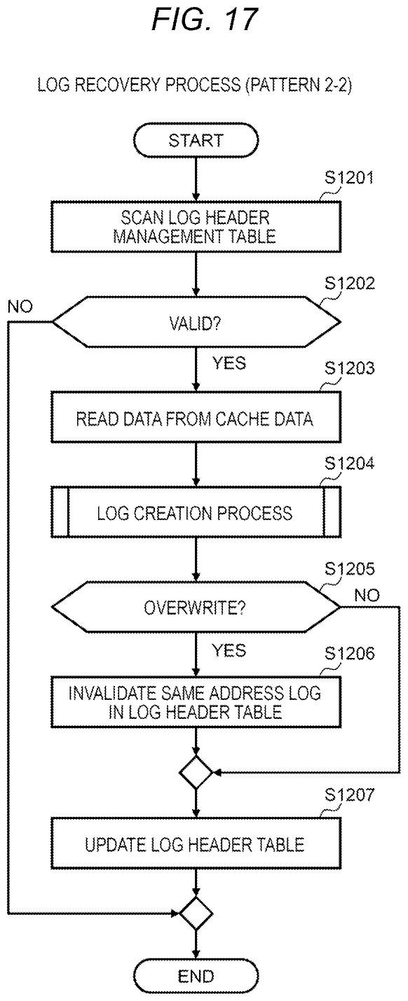

FIG. 17 is a flowchart of the log recovery process (pattern 2-2: cache data log recovery).

The storage controller of the node that recovers the cache data log scans the cache data log header management table (step S1201) and determines whether the log is valid (step S1202). If the log is invalid (step S1202; NO), since the log has already been destaged, the process for the log ends.

If the log is valid (step S1202; YES), the storage controller reads data from the cache data (step S1203) and uses the read data to generate a log again (step S1204).

After that, the storage controller determines whether it is overwrite (step S1205). That is, the cache data log header management table is referred to search for a log with the same address, and if so, overwrite is determined. If it is overwrite (step S1205; YES), the log of the same address in the log header management table is invalidated (step S1206). This invalidation sets the valid flag to “invalid”. After step S1206, or if it is not overwrite (step S1205; NO), the storage controller adds the log header of the log created in step S1203 to the log header management table (step S1207) and ends the process.

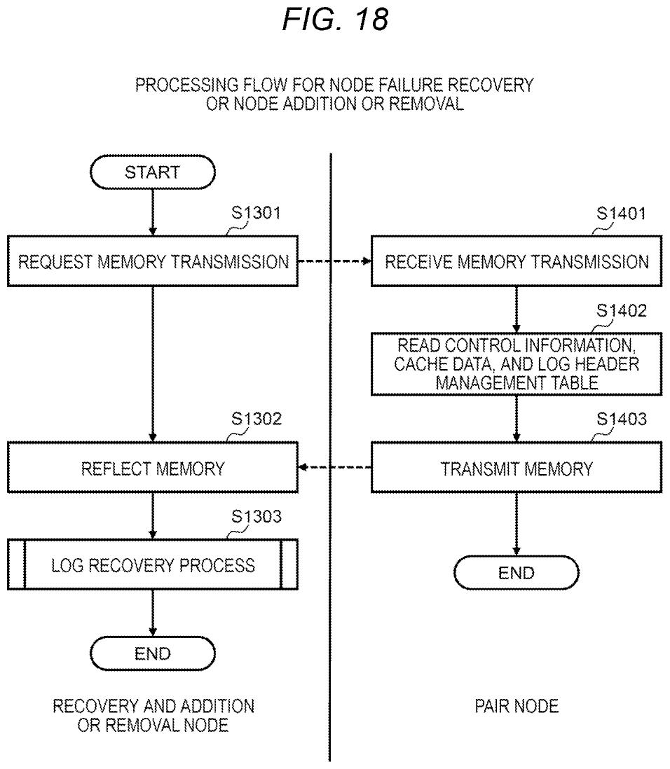

FIG. 18 is a flowchart for node failure recovery and node addition and removal. The log recovery process can also handle node failure recovery and node addition and removal. Either pattern 1 or pattern 2 can be used for the log recovery process.

First, a request for memory transfer is made to the pair node from the node that performs failure recovery or node addition and removal (step S1301).

When the pair node receives the memory transfer request (step S1401), the pair node reads the control information, cache data, and log header management table from the memory (step S1402) and transfers them to the request source (step S1403).

The node performing failure recovery or node addition and removal reflects the received contents in the memory (step S1302), regenerates the log by the log recovery process (step S1303), and ends the process.

It is also possible to deal with the addition and removal of drives in the same way. When the number of drives changes, the logs need to be relocated, and thus, the storage controller resets the log area after changing the number of drives. After resetting, the log is regenerated and stored again by the log recovery process (either pattern 1 or pattern 2 can be used).

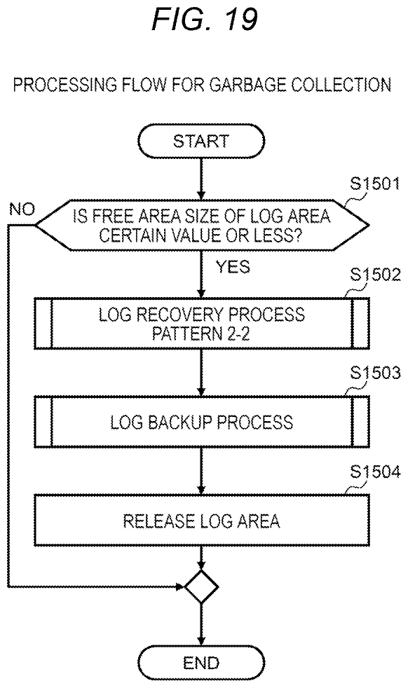

FIG. 19 is a flowchart of garbage collection of the cache data log area. The recovery process in this case applies the recovery process pattern 2-2.

The data stored in the cache data log area becomes unnecessary (invalid) due to overwrite or the reflecting of the cache in the drive.

Fragmentation occurs because the area storage order and the invalidation order do not match. Therefore, garbage collection is executed when the continuous free area is below a certain value.

Specifically, the storage controller determines whether the continuous free area size of the log area is equal to or less than a certain value (step S1501). If the free area size exceeds a certain value (step S1501; NO), the process is terminated.

If the free area size is equal to or less than the certain value (step S1501; YES), the storage controller executes the log recovery process pattern 2-2 for an area equal to or larger than a predetermined value, regenerates valid logs identified from the log header management table, and stores the valid logs in the log buffer (step S1502).

After that, the storage controller writes the log stored in the log buffer to the disk by the log backup process (step S1503), releases the area in which the old log was stored (step S1504), and ends the process.

As described above, the disclosed storage system 100 is a storage system including a plurality of storage nodes 103 each including a non-volatile storage device 1033, a storage controller 1083 that processes data read and write from and to the storage device, and a volatile memory 1032, in which the storage controller 1083 stores data relating to the data write in the memory 1032, and stores data that needs to be non-volatile, among the data stored in the memory 1032, in the storage device 1033 as log data, makes the log data stored in the storage device 1033 redundant among a plurality of storage nodes, and performs a recovery process when a problem occurs in the log data stored in the storage device 1033 in one of the storage nodes.

According to this configuration and operation, it is possible to implement a storage system with both high performance and high reliability by enabling the expansion of log data.

Further, the plurality of storage nodes makes the data stored in the memory 1032 redundant, and when a failure occurs in the storage device 1033 of one of the storage nodes, the storage controller 1083 of each storage node recreates the log data from the data stored in the memory on its own node.

Therefore, log re-redundancy can be achieved without drive access and network communication.

Also, when a failure occurs in the storage device 1033 of one of the storage nodes, the storage controller 1083 of the storage node can make the log data redundant again by acquiring the log data stored in the storage device 1033 of the other storage node.

Therefore, the log in the storage device 1033 can be reliably protected.

Also, the plurality of storage nodes includes an active node in an active state and a standby node in a standby state, and the storage controller 1083 of the active node stores control information and cache data in a log buffer, creates the log data from control information and cache data in the log buffer, and transfers the control information and cache data in the log buffer to the standby node, and the storage controller 1083 of the standby node uses the control information and cache data received from the active node to match the state of the memory with the active node and generate the log data using control information and cached data received from the active node.

Therefore, it is possible to synchronize the memory states of a plurality of storage nodes.

Also, the storage controller 1083 of the active node is characterized by determining whether the control information and cache data need to be non-volatile and storing the control information and cache data that need to be non-volatile in the log buffer.

Therefore, control information and cache data can be efficiently non-volatile.

Also, the storage controller 1083 of the active node writes the cache data to the storage device 1033 in log units and performs garbage collection to collect free area.

Therefore, cache data can be made efficiently non-volatile.

Further, if the log data is lost in any one of the plurality of storage nodes belonging to the same group, all the storage nodes belonging to the group stores the base image of the control information in the storage device of its own node as at least part of the log data.

Therefore, it is possible to synchronize log data of control information possessed by a plurality of storage nodes belonging to the same group.

The storage controller 1083 makes data stored in the memory 1032 non-volatile when the number of storage nodes changes.

Therefore, log data can be synchronized even if the number of storage nodes changes.

The present invention is not limited to the above embodiments and includes various modifications. For example, the above-described embodiments have been described in detail in order to describe the present invention in an easy-to-understand manner, and are not necessarily limited to those having all the described configurations. Moreover, not only deletion of such a configuration but also replacement and addition of the configuration are possible.

What is claimed is:

1. A storage system comprising a plurality of storage nodes each including a non-volatile storage device, a storage controller that processes data read and write from and to the storage device, and a volatile memory, wherein the storage controller stores data related to the data write in the memory, among the data stored in the memory, stores data that needs to be non-volatile in the storage device as log data, makes the log data stored in the storage device redundant among a plurality of storage nodes, and performs a recovery process for the log data when a problem arises with log data stored in the storage device of one of the storage nodes.

2. The storage system according to claim 1, wherein the plurality of storage nodes makes the data stored in the memory redundant, and if a failure occurs in the storage device of one of the storage nodes, the storage controller of each storage node re-creates the log data from the data stored in a memory of its own node.

3. The storage system according to claim 1, wherein when a failure occurs in the storage device of one of the storage nodes, the storage controller of the storage node can acquire the log data stored in the storage devices of other storage nodes to make the log data redundant again.

4. The storage system according to claim 1, wherein the plurality of storage nodes includes an active node in an active state and a standby node in a standby state, and the storage controller of the active node stores control information and cache data in a log buffer, creates the log data from control information and cache data in the log buffer, and transfers the control information and cache data in the log buffer to the standby node, and the storage controller of the standby node matches the state of the memory with the active node using the control information and cache data received from the active node and generates the log data using the control information and cache data received from the active node.

5. The storage system according to claim 4, wherein the storage controller of the active node determines whether the control information and cache data need to be non-volatile, and stores the control information and cache data that need to be non-volatile in the log buffer.

6. The storage system according to claim 4, wherein the storage controller of the active node writes the cache data to the storage device in log units and performs garbage collection to collect free area.

7. The storage system according to claim 4, wherein when the log data is lost in any one of the plurality of storage nodes belonging to the same group, all storage nodes belonging to the group store the base image of the control information in the storage device of its own node as at least part of the log data.

8. The storage system according to claim 1, wherein the storage controller executes non-volatilization of data stored in the memory when the number of the storage nodes changes.

9. A storage control method in a storage system including a plurality of storage nodes each including a non-volatile storage device, a storage controller that processes data read and write from and to the storage device, and a volatile memory, wherein the storage controller stores data related to the data write in the memory, stores data that needs to be non-volatile among the data stored in the memory in the storage device as log data, makes the log data stored in the storage device redundant among a plurality of storage nodes, and performs a recovery process for log data when a problem occurs in log data stored in a storage device of one of the storage nodes.
